(19) United States
(12) Patent Application Publication
(10) Pub. No.: US 2025/0360407 A1
(43) Pub. Date: Nov. 27, 2025

(54) VIRTUAL SCENE DISPLAY METHOD AND APPARATUS, COMPUTER DEVICE, AND STORAGE MEDIUM

(71) Applicant: Tencent Technology (Shenzhen) Company Limited, Shenzhen (CN)

(72) Inventors: Xuyang GUO, Shenzhen (CN); Jie XIAO, Shenzhen (CN)

(21) Appl. No.: 19/298,110

(22) Filed: Aug. 12, 2025

Related U.S. Application Data
(63) Continuation of application No. PCT/CN2024/083771, filed on Mar. 26, 2024.

(30) Foreign Application Priority Data
May 24, 2023 (CN) 202310596039.3

(51) Int. Cl. A63F 13/5252; A63F 13/533; A63F 13/5372; A63F 13/5375

(52) U.S. Cl. CPC A63F 13/5252; A63F 13/533; A63F 13/5372; A63F 13/5375

(57) ABSTRACT

A virtual scene display method performed by a computer device includes: displaying a first local scene at a spawn point selection stage of a virtual battle, wherein the first local scene including a target virtual object is a local scene picture of a three-dimensional (3D) virtual scene under a first close-shot lens view; generating and displaying a plurality of scene pictures of the 3D virtual scene sequentially during a gradual elevation of a lens view from the first close-shot lens view to a wide-shot lens view; displaying a second local scene including a plurality of spawn points when the lens view changes to the wide-shot lens view, wherein the second local scene including a plurality of spawn points is a local scene picture of the 3D virtual scene under the wide-shot lens view; and selecting a target spawn point from the plurality of spawn points for the target virtual object.

### CROSS-REFERENCE TO RELATED APPLICATIONS

This application is a continuation application of PCT Patent Application No. PCT/CN2024/083771, entitled “VIRTUAL SCENE DISPLAY METHOD AND APPARATUS, COMPUTER DEVICE, AND STORAGE MEDIUM” filed on Mar. 26, 2024, which claims priority to Chinese Patent Application No. 2023105960393, entitled “VIRTUAL SCENE DISPLAY METHOD AND APPARATUS, COMPUTER DEVICE, STORAGE MEDIUM AND PROGRAM PRODUCT” filed with the China National Intellectual Property Administration on May 24, 2023, both of which are incorporated by reference in their entirety.

### FIELD OF THE TECHNOLOGY

This application relates to the field of computer technologies, and in particular, to a virtual scene display method and apparatus, a computer device, a storage medium, and a computer program product.

### BACKGROUND OF THE DISCLOSURE

With development of computer technologies and Internet technologies, increasing battle games merge, which bring immersive game experience to players. Battle games are games in which a plurality of user accounts compete in the same virtual game scene, such as multiplayer online battle arena (MOBA) games.

Usually, before a battle game starts, each user account needs to select an initial position, that is, a spawn point, in a virtual game scene for a to-be-controlled virtual object, and then may control the virtual object to move in the virtual game scene from the spawn point and battle with a virtual object controlled by another player.

In the related art, at a point selection stage of a battle game, a simplified planar diagram of a virtual game scene is usually provided in the battle game, and a player selects a spawn point of a virtual object from a plurality of spawn points in the simplified planar diagram. However, the simplified planar diagram does not provide a virtual game scene in which the virtual object is in a battle. Therefore, during selection of a spawn point, a player cannot directly view an environment around the spawn point, which cannot provide immersive game experience, and results in poor user experience. In addition, after an identity is selected in the simplified planar diagram, the player needs to perform switching back to a local scene corresponding to a location selected by a player in the virtual game scene. Switching back and forth between the simplified planar diagram and the virtual game scene to select a spawn point not only causes complex operations, but also requires additional configuration and storage of the simplified planar diagram, which occupies a relatively large quantity of processing resources of a terminal and a server.

### SUMMARY

This application provides a virtual scene display method performed by a computer device. The method includes:
displaying a first local scene at a spawn point selection stage of a virtual battle, wherein the first local scene including a target virtual object is a local scene picture of a three-dimensional (3D) virtual scene under a first close-shot lens view;
generating and displaying a plurality of scene pictures of the 3D virtual scene sequentially during a gradual elevation of a lens view from the first close-shot lens view to a wide-shot lens view;
displaying a second local scene including a plurality of spawn points when the lens view changes to the wide-shot lens view, wherein the second local scene including a plurality of spawn points is a local scene picture of the 3D virtual scene under the wide-shot lens view; and
selecting a target spawn point from the plurality of spawn points for the target virtual object.

This application further provides a computer device. The computer device includes a memory and a processor. The memory has computer-readable instructions stored therein, and the processor, when executing the computer-readable instructions, causes the computer device to implement the operations of the foregoing virtual scene display method.

This application further provides a non-transitory computer-readable storage medium. The computer-readable storage medium has computer-readable instructions stored therein. The computer-readable instructions, when executed by a processor of a computer device, cause the computer device to implement the operations of the foregoing virtual scene display method.

This application further provides a computer program product. The computer program product includes computer-readable instructions. The computer-readable instructions, when executed by a processor, implements the operations of the foregoing virtual scene display method.

### BRIEF DESCRIPTION OF THE DRAWINGS

FIG. 1 is a diagram of an application environment of a virtual scene display method according to an embodiment.

FIG. 2 is a diagram of an application environment of a virtual scene display method according to another embodiment.

FIG. 3 is a schematic diagram of a simplified two-dimensional (2D) planar map for selecting a spawn point in the related technology.

FIG. 4 is a schematic flowchart of a virtual scene display method according to an embodiment.

FIG. 5 is a schematic diagram of a first local scene in a three-dimensional (3D) virtual scene according to an embodiment.

FIG. 6 is a schematic diagram of a lens view elevation process according to an embodiment.

FIG. 7 is a schematic diagram of a third local scene according to an embodiment.

FIG. 8 is a schematic diagram of a lens view lowering process according to an embodiment.

FIG. 9 is a schematic diagram of an operation control displayed in a third local scene in an overlay manner according to an embodiment.

FIG. 10 is a schematic diagram of a plurality of marked spawn points according to an embodiment.

FIG. 11 is a schematic diagram of a spawn point prompt area displayed in an overlay manner according to an embodiment.

FIG. 12 is a schematic diagram of a displayed recommended path according to an embodiment.

FIG. 13 is a schematic diagram of scene configuration information of a 3D virtual map according to an embodiment.

FIG. 14 is a timing diagram of a virtual scene display method according to an embodiment.

FIG. 15 is a structural block diagram of a virtual scene display apparatus according to an embodiment.

FIG. 16 is a structural block diagram of a virtual scene display apparatus according to another embodiment.

FIG. 17 is an internal structural diagram of a computer device according to an embodiment.

### DESCRIPTION OF EMBODIMENTS

To describe technical solutions of embodiments of this application more clearly, drawings required for describing the embodiments or the conventional technology are briefly described below. Apparently, the drawings in the following description merely show the embodiments of this application, and a person of ordinary skill in the art may derive other drawings from the disclosed drawings without creative efforts.

Multiplayer online battle arena (MOBA) game: It may also be referred to as an action real-time strategy (ARTS) game. A rule of the game is as follows: Players are usually divided into two teams, the two teams compete with each other in a game map (that is, a virtual game scene), and each player controls a selected virtual object through an interface. Usually, each player only needs to control a virtual object selected by the player.

Spawn point: It represents an initial position of a virtual object of a player in a game map, which is usually a starting position of the virtual object of the player when the player enters a battle stage of a battle game.

Three-dimensional scene (3D scene): It is a scene in which complex and abstract information is manifested in a 3D art form such as a 3D model, which has advantages of being intuitive, clear, and easy to understand.

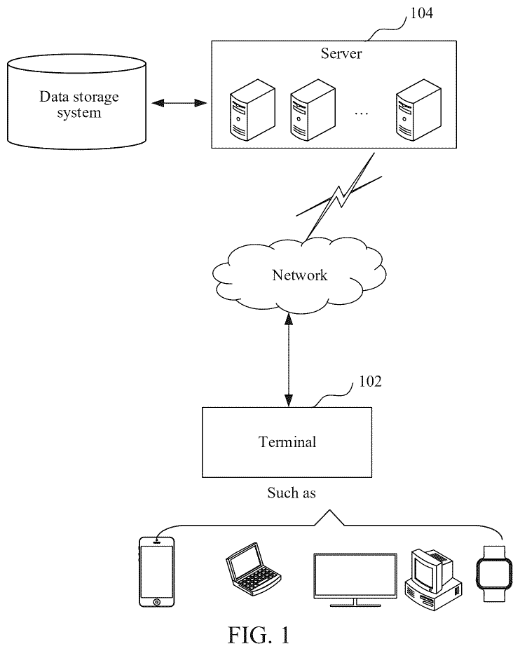

A virtual scene display method provided in the embodiments of this application may be applied to an application environment shown in FIG. 1. A terminal 102 communicates with a server 104 through a network. A data storage system may store data the server 104 needs to process. The data storage system may be integrated on the server 104, or may be arranged on the cloud or another server. In an embodiment, the terminal 102 may display a first local scene at a spawn point selection stage of a virtual battle. The first local scene is a local scene of a 3D virtual scene under a first close-shot lens view. The first local scene includes a target virtual object. The virtual object can be displayed under the first close-shot lens. After displaying of the virtual object ends, the terminal may display a gradually elevating lens picture of the 3D virtual scene. The gradually elevating lens picture is a scene picture of the 3D virtual scene under a gradually elevating lens view during gradual elevation of the lens view from the first close-shot lens view to a wide-shot lens view. The terminal may display a second local scene when the lens view changes to the wide-shot lens view. The second local scene is a local scene of the 3D virtual scene under the wide-shot lens view. The second local scene includes a plurality of spawn points. The terminal may select a target spawn point is selected from the plurality of spawn points.

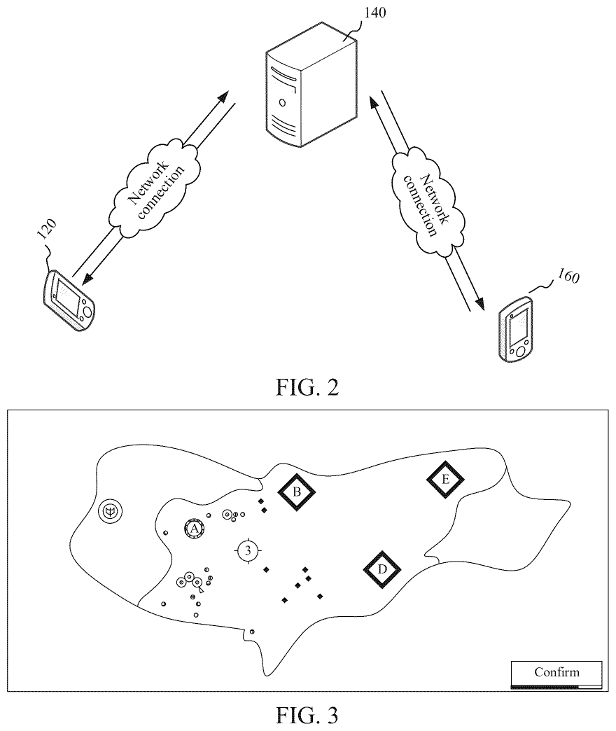

FIG. 2 is a structural block diagram of a game system 100 according to an exemplary embodiment of this application. The game system 100 includes a first terminal 120, a server 140, and a second terminal 160.

The first terminal 120 is connected to the server cluster 120 through a wireless network or a wired network. The first terminal 120 may be at least one of a smart phone, a game console, a desktop computer, a tablet computer, an e-book reader, a moving picture experts group audio layer III (MP3) player, a moving picture experts group audio layer IV (MP4) player, an augmented reality (AR) device, a virtual reality (VR) device, and a laptop portable computer. The first device 120 has a client (or referred to as an application) of a battle game type installed and run therein, which is briefly referred to as a battle game client, a game client, a battle client, or a client. The client may be any one of an instant battle game client, a role play game client, a MOBA game client, a multiplayer online gunshot game client, or a multiplayer online survival game client. The first terminal 120 is a terminal used by a first user, and a client in the first terminal 120 is logged with a first user account. The first terminal 120 is connected to the server 140 through a wireless network or a wired network.

The server 140 includes at least one of one server, a plurality of servers, a cloud computing platform, and a virtualization center. The server 140 is configured to provide a background service for a client supporting the virtual pets. In some embodiments, the server 140 is in charge of primary computing, and the first terminal 120 and the second terminal 160 are in charge of secondary computing. Alternatively, the server 140 is in charge of secondary computing, and the first terminal 120 and the second terminal 160 are in charge of primary computing. Alternatively, the server 140, the first terminal 120, and the second terminal 160 perform collaborative computing by using a distributed computing architecture. The second terminal 160 has a battle game client installed and run therein, which is briefly referred to as a battle game client or a client. The client may be any one of an instant battle game client, a role play game client, a MOBA game client, a multiplayer online gunshot game client, or a multiplayer online survival game client. The second terminal 160 is a terminal used by a second user. A client in the second terminal 120 is logged with a second user account.

In some embodiments, the first user account and the second user account are in the same virtual social network. In some embodiments, the first user account and the second user account may belong to the same team or the same organization, or may have a friend relationship or temporary communication permission. In some embodiments, the first user account and the second user account may belong to different teams, different organizations, or two hostile groups.

In some embodiments, the client installed in the first terminal 120 is the same as the client installed in the second terminal 160, or the clients installed in the two terminals are clients of the same type on different operating system platforms. Different operating systems include an Android operating system, an IOS operating system, a Windows operating system, or an operating system dedicated for a game host.

The first terminal 120 may generally refer to one of a plurality of terminals, and the second terminal 160 may generally refer to one of a plurality of terminals. A terminal mentioned in this embodiment may be the first terminal 120 or the second terminal 160 as an example. The foregoing terminals in FIG. 1 and FIG. 2 may be, but are not limited to, various personal computers, notebook computers, smartphones, tablet computers, Internet of Things devices, and portable wearable devices. The Internet of Thing devices may be a smart speaker, a smart television, a smart air conditioner, a smart on-board device, or the like. The portable wearable devices may be a smart watch, a smart bracelet, a head-mounted device, or the like. The foregoing server in FIG. 1 and FIG. 2 may be implemented as an independent server or a server cluster composed of a plurality of servers.

A person skilled in the art may understand that more or fewer terminals may be provided. For example, only one terminal, or dozens or hundreds of terminals, or more terminals may be provided. A quantity of terminals and a device type are not limited in the embodiments of this application. Typically, one battle game needs a plurality of terminals, for example, 8 or 10 terminals. Virtual objects corresponding to the plurality of terminals are divided into two hostile groups, to perform an arena battle.

In the related technology, at a spawn point selection stage of a virtual battle, a spawn point is selected in another simplified 2D planar map corresponding to a 3D virtual scene. FIG. 3 is a schematic diagram of a simplified 2D planar map for selecting a spawn point in the related technology. It may be learned that, the simplified 2D planar map is not used as a 3D virtual scene in which virtual objects perform a virtual battle. In other words, the point selection process is separated from the 3D virtual scene in which virtual objects perform a virtual battle. During selection of a spawn point, a player cannot directly view an environment around the spawn point, which cannot provide immersive game experience, and results in poor user experience. In addition, after an identity is selected in the simplified planar diagram, the player needs to perform switching back to a local scene corresponding to a location selected by the player in the virtual game scene. Switching back and forth between the simplified planar diagram and the virtual game scene to select a spawn point not only causes complex operations, but also requires additional configuration and storage of the simplified planar diagram on a terminal or a server, which occupies a relatively large quantity of processing resources of a terminal and a server.

In the virtual scene display method provided in this embodiment of this application, a first local scene is displayed at a spawn point selection stage of a virtual battle. The first local scene is a local scene of a 3D virtual scene under a first close-shot lens view. The first local scene includes a target virtual object. After the target virtual object is displayed, a gradually elevating lens picture of the 3D virtual scene is displayed. A scene picture of the 3D virtual scene under a gradually elevating lens view during gradual elevation of the lens view from the first close-shot lens view to a wide-shot lens view is the gradually elevating lens picture. A second local scene is displayed when the lens view changes to the wide-shot lens view. The second local scene is a local scene of the 3D virtual scene under the wide-shot lens view. The second local scene includes a plurality of spawn points. Then a target spawn point may be directly selected from the 3D scene. In other words, the lens view displaying the virtual object is directly switched to the wide-shot lens view of the 3D virtual scene, so that the player can observe the scene environment of the 3D virtual scene when selecting the spawn point. In addition, the lens view switching is seamless, providing very smooth experience. The lens switching is completely performed in the 3D virtual scene, without a need to perform camera movement to switch to the simplified planar diagram to select the spawn point, which avoids interruption of immersive experience of the 3D virtual scene as a result of switching between the 3D virtual scene and the simplified planar diagram, thereby significantly improving game experience of players. In addition, neither additional configuration and storage of the simplified planar diagram on a terminal or a server nor additional rendering of the simplified planar diagram on a terminal or a server is required, thereby reducing processing resources of the terminal and the server that need to be occupied.

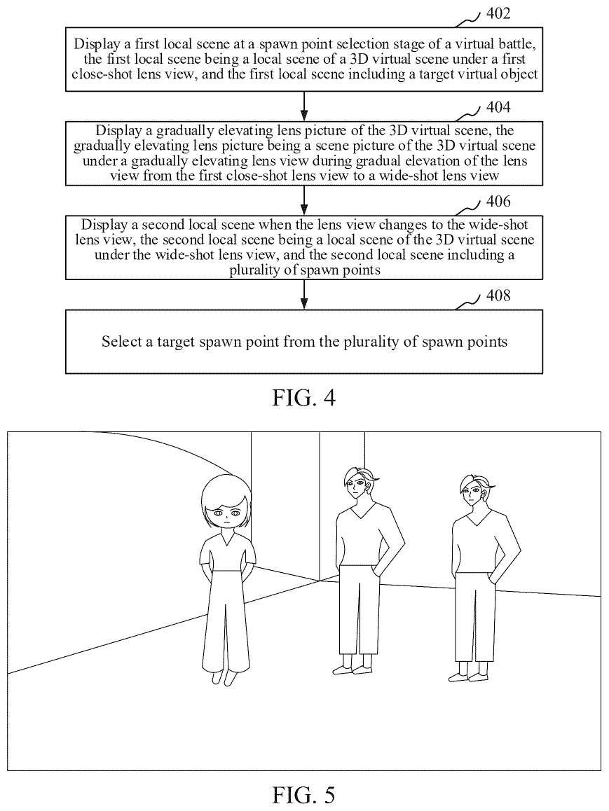

In an embodiment, as shown in FIG. 4, a virtual scene display method is provided. For example, the method is applied to the terminal in FIG. 1. The method includes the following operations:

Operation 402: Display a first local scene at a spawn point selection stage of a virtual battle, the first local scene being a local scene of a 3D virtual scene under a first close-shot lens view, and the first local scene including a target virtual object.

The virtual battle is a virtual fight between at least two virtual objects in the same 3D virtual scene. The 3D virtual scene is a virtual battle map generated based on a virtual scene, and is a complete virtual scene to which the virtual objects may move during the virtual battle. The local scene is a part of the 3D virtual scene, which includes at least one virtual object. The virtual object is a virtual character model controlled through a terminal to implement the virtual battle. The at least one virtual object includes a target virtual object currently controlled through the terminal, and may further include another virtual object controlled through another terminal. The at least one virtual object may belong to the same camp of the virtual battle, in other words, include a target virtual object and a friend virtual object, or may belong to different camps of the virtual battle, in other words, include a target virtual object and an enemy virtual object, or may include both a friend virtual object and an enemy virtual object.

The 3D virtual scene includes a plurality of selectable spawn points, and the player may select, through the terminal, a spawn point for the target virtual object controlled during the virtual battle, and use the spawn point as a starting position of the target virtual object during the virtual battle. The first close-shot lens view is a lens view configured for displaying the target virtual object.

In an embodiment, at the spawn point selection stage of the virtual battle, the terminal displays the first local scene by default. The first local scene is a local scene of the 3D virtual scene displayed under a default first close-shot lens view when the target virtual object in the 3D virtual scene is used as a to-be-observed object.

The target object may be located at any location in the 3D virtual scene, or may be located at any location except a key location (such as a spawn point, an attack area, or a tower creation area) in the 3D virtual scene, or may be located at any one of the plurality of spawn points. In other words, the target virtual object is located at a default preset spawn point.

The lens view is an angle for observing the 3D virtual scene. Different scene pictures may be observed at different lens views. The terminal displays the scene pictures. The scene picture displayed by the terminal may be a scene picture during observation of the target virtual object in the 3D virtual scene through a camera model in the 3D virtual scene. In some embodiments, in a virtual battle stage, the camera model automatically follows the target virtual object in the 3D virtual scene. To be specific, when a position of the target virtual object in the 3D virtual scene changes, a position of the camera model changes simultaneously with the position of the target virtual object in the 3D virtual scene. In the spawn point selection stage before the virtual battle stage, the camera model may further observe the virtual 3D scene based on different scene lens parameters (that is, lens views) in the 3D virtual scene, to display different local scenes in the 3D virtual scene. The camera model is a 3D model around the target virtual object in the 3D virtual scene. When the lens view of the camera model adopts a first-person view, the camera model is located near a head of the target virtual object or on the head of the target virtual object. When the lens view adopts a third-person view, the camera model may be located behind the target virtual object and bound to the target virtual object, or may be located at any location at a preset distance from the target virtual object. The target virtual object in the 3D virtual scene may be observed at different angles through the camera model. In some embodiments, when the third-person view is a first-person over-the-shoulder view, the camera model is located behind the target virtual object (for example, behind the head and shoulders of the target virtual object). In some embodiments, in addition to the first-person view and the third-person view, the lens view further includes other views, such as a top-down view and bird's-eye view. When the top-down view is adopted, the camera model may be located over the head of the target virtual object. The top-down view is a view for observing the 3D virtual scene at an angle from the air. In some embodiments, the camera model is actually not displayed in the 3D virtual scene. In other words, the camera model is not displayed in the 3D virtual scene displayed on the user interface.

The camera model may rotate with the target virtual object as a rotation center. For example, the camera model rotates with any point of the target virtual object as the rotation center. During the rotation, the camera model not only rotates in angle, but also deviates in displacement. A distance between the camera model and the rotation center remains unchanged during the rotation. To be specific, the camera model rotates on a surface of a sphere with the rotation center as a spherical center. Any point of the target virtual object may be the head or a torso of the target virtual object, or may be any point around the target virtual object, which is not limited in this embodiment of this application. In some embodiments, the camera model may further observe the target virtual object in different directions of the target virtual object at preset angles.

In an embodiment, the first local scene displayed by the terminal by default is a local scene displayed in a 3D virtual scene of the 3D virtual scene displayed under a default first lens view when the target virtual object is located at a preset spawn point, and the preset spawn point is a default spawn point of the 3D virtual scene. In subsequent operations, the player may re-select a spawn point for the virtual object from the plurality of spawn points, and perform a virtual battle from the selected spawn point. In other words, the displaying a first local scene at a spawn point selection stage of a virtual battle includes: displaying a virtual battle interface at the spawn point selection stage of the virtual battle; and displaying the first local scene of the 3D virtual scene in the virtual battle interface, the first local scene being a local scene of the 3D virtual scene under the first close-shot lens view, the first local scene being a local scene at a preset spawn point of the 3D virtual scene, and the first local scene including the target virtual object located at the preset spawn point. In some embodiments, the first local scene includes virtual objects of a first camp of the virtual battle, the virtual objects of the first camp including the target virtual object, and the virtual objects of the first camp being located at the preset spawn point.

In an embodiment, the first local scene further includes another virtual object belonging to the same camp as the target virtual object, and the first close-shot lens view is a lens view configured for displaying all virtual objects of the same camp.

In some embodiments, the first local scene is a static scene. In other words, the target virtual object may be displayed at a default angle. In another embodiment, the first local scene is a dynamic scene. In other words, the first close-shot lens view includes a plurality of lens views close to each other, and may be configured for observing details of different parts of the target object, to completely display the target virtual object.

In an embodiment, the displaying a first local scene of a 3D virtual scene under a first close-shot lens view includes: reading scene configuration information of the 3D virtual scene of the virtual battle, the scene configuration information including the preset spawn point in the 3D virtual scene and a scene lens parameter of the preset spawn point, the scene lens parameter indicating that a lens view corresponding to the 3D virtual scene at the preset spawn point is the first close-shot lens view; and displaying the first local scene based on the first close-shot lens view, the first local scene being a local scene in which the target virtual object is located at the preset spawn point of the 3D virtual scene.

The scene configuration information is configuration information about the 3D virtual scene. The scene configuration information includes the preset spawn point in the 3D virtual scene and the scene lens parameter of the preset spawn point, and the scene lens parameter indicates that the lens view corresponding to the 3D virtual scene at the preset spawn point is the first close-shot lens view. In other words, the terminal may read the scene configuration information of the 3D virtual scene, to obtain scene lens parameters respectively corresponding to the plurality of spawn points in the 3D virtual scene from the scene configuration information, and determine a default spawn point in the plurality of spawn points. The scene lens parameters may include a focal length, an angle, a position, a lens special effect, and the like. A lens view for observing the 3D virtual scene may be determined based on the scene lens parameters, a local scene of the 3D virtual scene may be observed from the lens view, and the terminal may display the local scene. The scene lens parameter of the preset spawn point corresponds to the first close-shot lens view, and the terminal may display the first local scene when the target virtual object is located at the preset spawn point of the 3D virtual scene based on the first close-shot lens view. In some embodiments, the game application running on the terminal may provide a plurality of 3D virtual scenes, and each 3D virtual scene has a corresponding scene configuration parameter.

FIG. 5 is a schematic diagram of a first local scene in a 3D virtual scene according to an embodiment. Referring to FIG. 5, at a spawn point selection stage of a virtual battle, the first local scene is displayed by default in an interface, the first local scene being a part of the 3D virtual scene. In other words, a virtual object model representing all teammates is displayed in the 3D virtual scene by default, so that the player can fully observe surroundings in the 3D virtual scene. In this case, a close-up view of each virtual object may be further played, to fully display skins worn by each virtual object, actions, and expressions.

Operation 404: Display a gradually elevating lens picture of the 3D virtual scene, the gradually elevating lens picture being a scene picture of the 3D virtual scene under a gradually elevating lens view during gradual elevation of the lens view from the first close-shot lens view to a wide-shot lens view.

The first close-shot lens view mentioned above is a close-shot lens view. The close-shot lens view is a lens view at which a target object located in the 3D virtual scene can be observed, but a visual field thereof is limited. Therefore, neither distribution of the spawn points in the 3D virtual scene can be observed, nor a global scene of the 3D virtual scene can be observed. To enable the player to directly select a spawn point from the 3D virtual scene, after displaying the target virtual object through the first local scene (that is, the scene under the first close-shot lens view) of the 3D virtual scene, the terminal starts to display the gradually elevating lens picture of the 3D virtual scene. To prevent interruption of immersive game experience as a result of the player leaving the 3D virtual scene in which the virtual battle is located to select a spawn point, the gradually elevating lens picture displayed by the terminal is a scene picture of the 3D virtual scene that may be observed during gradual elevation of the lens view from the first close-shot lens view to the wide-shot lens view, that is, a scene picture of the 3D virtual scene under the gradually elevating lens view. The wide-shot lens view is a lens view at which distribution of the spawn points in the 3D virtual scene can be observed, or even the global scene of the 3D virtual scene can be observed, so that the player can learn surroundings of a spawn point selected by the player, and adopt a corresponding battle policy and implement the battle policy in cooperation with a player of the same camp, which avoids a problem that each game battle occupies a relatively large quantity of processing resources of the terminal and the server caused by an excessively long time of the entire game battle as a result of spending a relatively long time to find a friend for cooperation or find an enemy virtual object for a battle. In an embodiment, the wide-shot lens view is a bird's-eye view of the 3D virtual scene.

In an embodiment, after displaying the foregoing first local scene, the terminal may directly automatically display the gradually elevating lens picture of the 3D virtual scene without any operation of the player. To be specific, the player does not need to manually zoom out the 3D virtual scene. For example, after the target virtual object is displayed through the first local scene for a preset duration (for example, 2 s), the gradually elevating lens picture of the 3D virtual scene may be directly automatically displayed. In this way, a quantity of active operations of the player can be reduced, and an operation time before each game is started is reduced, so that a game battle can be started as soon as possible, thereby reducing a duration of each game battle.

In an embodiment, the scene configuration information of the 3D virtual scene further includes an elevating lens parameter corresponding to the preset spawn point, the elevating lens parameter being configured for indicating a plurality of gradually elevating lens views. The displaying a gradually elevating lens picture of the 3D virtual scene includes: reading the scene configuration information of the 3D virtual scene of the virtual battle, the scene configuration information including a plurality of gradually elevating lens views, and displaying, based on the plurality of gradually elevating lens views, scene pictures of the 3D virtual scene under the plurality of gradually elevating lens views during gradual elevation and change from the first close-shot lens view to the wide-shot lens view.

The scene configuration information of the 3D virtual scene further includes an elevating lens parameter corresponding to the preset spawn point, the elevating lens parameter being configured for indicating a plurality of gradually elevating lens views. To be specific, in the battle game, a preset spawn point may be configured for the 3D virtual scene, and a corresponding elevating lens parameter is configured for the preset spawn point. The elevating lens parameter is configured for indicating a plurality of gradually elevating lens views. Each lens view has a corresponding scene lens parameter, that is, a focal length, an angle, a position, a lens special effect, and the like of a lens. In this case, the elevating lens parameter may be understood as a set of scene lens parameters respectively corresponding to the plurality of gradually elevating lens views. The terminal may determine a lens view for observing the 3D virtual scene based on a scene lens parameter, under which the local scene of the 3D virtual scene can be observed. The terminal may display the local scene. The terminal obtains a plurality of continuously changing scene lens parameters corresponding to the gradually elevating lens views, and may determine a plurality of continuous and gradually elevating lens views for observing the 3D virtual scene through the plurality of scene lens parameters. The gradually elevating lens picture of the 3D virtual scene may be observed through the lens views.

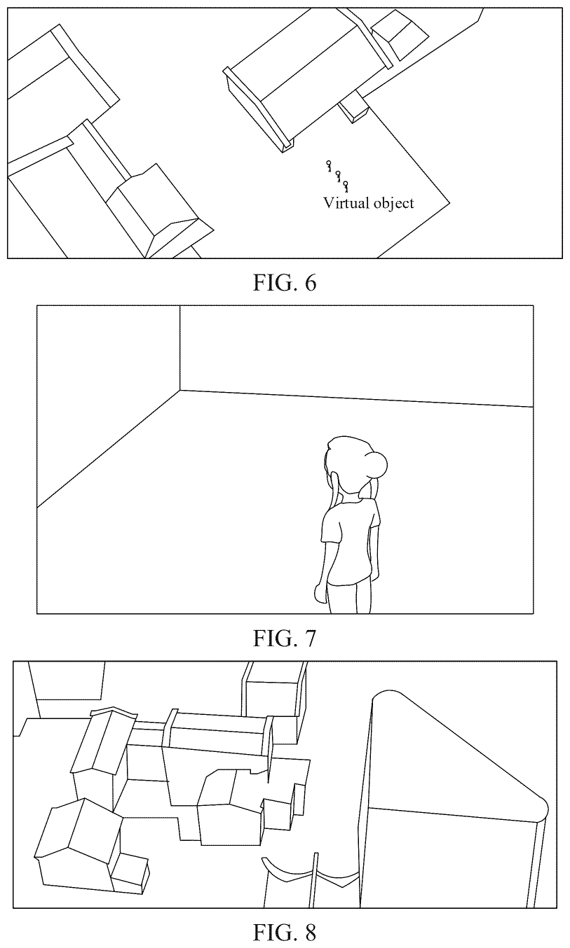

FIG. 6 is a schematic diagram of a lens view elevation process according to an embodiment. Referring to FIG. 6, the scene displayed by the terminal gradually elevates from the first local scene through the lens view. During the changing of the lens view, increasing scene pictures of the 3D virtual scene are formed under the gradually elevating lens view, elements in the 3D virtual scene are increasingly smaller, and the global scene of the 3D virtual scene is gradually displayed. In the process, the player can clearly learn surroundings in the 3D virtual scene, so that the player can have global understanding of the 3D virtual scene at the point selection stage before the virtual battle is started. In this way, the player can learn surroundings of a spawn point selected by the player, and adopt a corresponding battle policy and implement the battle policy in cooperation with a player of the same camp. In addition, interruption of immersive game experience as a result of leaving the 3D virtual scene in which the virtual battle is performed is avoided.

Operation 406: Display a second local scene when the lens view changes to the wide-shot lens view, the second local scene being a local scene of the 3D virtual scene under the wide-shot lens view, and the second local scene including a plurality of spawn points.

Specifically, when the lens view changes to the wide-shot lens view, the terminal displays the second local scene. The second local scene is a local scene displayed when the 3D virtual scene is used as a to-be-observed object, and a plurality of spawn points in the 3D virtual scene can be displayed in the local scene. To be specific, as the lens view gradually elevates and finally changes to the wide-shot lens view, the displayed second local scene includes a plurality of spawn points in the 3D virtual scene, and the player can observe positions of the plurality of spawn points in the 3D virtual scene and a relationship between the plurality of spawn points and surroundings (for example, the target area).

In an embodiment, when the lens view changes to the wide-shot lens view, the terminal may mark the plurality of spawn points in the 3D virtual scene in the displayed second local scene. The terminal may further mark key points in the 3D virtual scene in the displayed second local scene, such as the target area.

In an embodiment, when the lens view changes to the wide-shot lens view, the terminal may mark a selection status of another virtual object in the displayed second local scene in the same camp as the target virtual object, so that the player has global understanding about tactics planning and teammate distribution before the virtual battle, thereby improving game experience, and avoiding a problem that each game battle occupies a relatively large quantity of processing resources of the terminal and the server caused by an excessively long time of the entire game battle as a result of spending a relatively long time to find a teammate for cooperation or find an enemy virtual object for a battle. For example, the terminal may display object information, such as a nickname or an avatar, of a corresponding virtual object near a spawn point selected by another player for another virtual object of the same camp. For another example, the terminal may mark corresponding prompt information at a corresponding spawn point based on a selection status of each spawn point. The prompt information may be a quantity of players selecting the spawn point, a popularity value corresponding to the quantity, or the like.

In some embodiments, the terminal may further determine, based on game account information of a current player, whether the current player has a permission to view a point selection status of another virtual object in the same camp. If the player has the corresponding permission, the terminal may mark a point selection status of another virtual object in the displayed second local scene. If the player does not have the corresponding permission, the terminal does not mark a point selection status of another virtual object in the displayed second local scene. That the player has the corresponding permission may mean that the current player purchases a specified prop through a game account, or that the game account is a specified-level account, or that the current player has a specified virtual skill, or the like.

In an embodiment, when the lens view changes to a wide-shot lens view, the terminal may mark, in the displayed second local scene, a point selection status of another virtual object in the same camp as the target virtual object, that is, a first camp, and mark a point selection status of another virtual object in a different camp from the target virtual object, that is, a second camp. Information of different camps may be marked in different patterns, so that the current player can have global understanding of tactics planning and teammate distribution before the virtual battle, thereby improving game experience.

Operation 408: Select a target spawn point from the plurality of spawn points.

Specifically, the second local scene includes a plurality of optional spawn points, and the terminal may use, in response to a selection operation performed on the target spawn point of the plurality of spawn points, the selected target spawn point as the spawn point of the target virtual object in the 3D virtual scene.

According to the foregoing virtual scene display method and apparatus, computer device, storage medium, and computer program product, the first local scene of the 3D virtual scene under the first close-shot lens view is displayed at the spawn point selection stage of the virtual battle. The first local scene is a local scene of the 3D virtual scene under the first close-shot lens view. The first local scene includes the target virtual object. After the target virtual object is displayed, the gradually elevating lens picture of the 3D virtual scene is displayed. A scene picture of the 3D virtual scene under the gradually elevating lens view during the gradual elevation of the lens view from the first close-shot lens view to the wide-shot lens view is the gradually elevating lens picture. The second local scene is displayed when the lens view changes to the wide-shot lens view. The second local scene is a local scene of the 3D scene under the wide-shot lens view. The second local scene includes a plurality of spawn points. Then the target spawn point may be directly selected from the 3D virtual scene. In other words, the lens view displaying the virtual object is directly switched to the wide-shot lens view of the 3D virtual scene, so that the player can observe the scene environment of the 3D virtual scene when selecting the spawn point. In addition, the lens view switching is seamless, providing very smooth experience. The lens switching is completely performed in the 3D virtual scene, without a need to perform camera movement to switch to the simplified planar diagram to select the spawn point, which avoids interruption of immersive experience of the 3D virtual scene as a result of switching between the 3D virtual scene and the simplified planar diagram, thereby significantly improving game experience of players. In addition, neither additional configuration and storage of the simplified planar diagram on the terminal or the server nor additional rendering of the simplified planar diagram on the terminal or the server is required, thereby reducing processing resources of the terminal and the server that need to be occupied.

In an embodiment, after the selecting a target spawn point from the plurality of spawn points, the method further includes: displaying a third local scene, the third local scene being a local scene of the 3D virtual scene under a second close-shot lens view, and the third local scene including the target virtual object located at the target spawn point of the 3D virtual scene.

After the terminal displays the second local scene and selects the target spawn point from the plurality of spawn points in the second local scene in response to the interaction operation triggered by the player, the terminal may directly display the third local scene.

The terminal may display the target virtual object at the target spawn point of the 3D virtual scene. The third local scene is a local scene of the 3D virtual scene displayed under the second close-shot lens view when the target virtual object in the 3D virtual scene located at the target spawn point is used as a to-be-observed object. The second close-shot lens view is a lens view at which the target virtual object in the 3D virtual scene is “born at” the target spawn point can be observed. In an embodiment, the second close-shot lens view is a first-person view of the target virtual object located at the target spawn point.

FIG. 7 is a schematic diagram of a third local scene according to an embodiment. Referring to FIG. 7, the terminal displays the target virtual object at the selected target spawn point, and the displayed third local scene is a part of the 3D virtual scene. The target virtual object about to perform the virtual battle is displayed in the third local scene. In other words, before the virtual battle is formally started, the player can fully observe surroundings in the 3D virtual scene.

In this embodiment, the process from displaying the target virtual object through the first local scene to displaying the target virtual object at the target spawn point through the third local scene after the point selection is completed is not separated from the 3D virtual scene in which the virtual battle is performed, so that the player can fully observe surroundings in the 3D virtual scene, thereby improving immersive game experience of the player.

In an embodiment, before displaying a third local scene of the 3D virtual scene, the method further includes: displaying a gradually lowering lens picture of the 3D virtual scene, the gradually lowering lens picture being a scene picture of the 3D virtual scene under a gradually lowering lens view during gradual lowering of the lens view from the wide-shot lens view to the second close-shot lens view. The displaying a third local scene includes: displaying the third local scene when the lens view changes to the second close-shot lens view, the third local scene being the local scene of the 3D virtual scene under the second close-shot lens view, the third local scene being a local scene of the 3D virtual scene at the target spawn point, and the third local scene including the target virtual object located at the target spawn point.

In this embodiment, after the plurality of spawn points in the 3D virtual scene are displayed through the wide-shot lens view and the spawn point selection is completed, the gradually lowering lens picture of the 3D virtual scene starts to be displayed, and the third local scene is displayed when the lowering ends. To prevent a sense of separation as a result of the player directly returning to the close-shot lens after selecting the target spawn point, the gradually lowering lens picture displayed by the terminal is a scene picture of the 3D virtual scene that can be observed during the lowering of the lens view from the wide-shot lens view to the second close-shot lens view, that is, a scene picture of the 3D virtual scene under the gradually lowering lens view.

In an embodiment, after the foregoing second local scene is displayed and the player selects a spawn point from the second local scene as the target spawn point of the target virtual object, the terminal may directly automatically display the gradually lowering lens picture of the 3D virtual scene without any operation of the player. To be specific, the player does not need to manually zoom in the 3D virtual scene.

In an embodiment, the displaying a gradually lowering lens picture of the 3D virtual scene includes: reading the scene configuration information of the 3D virtual scene of the virtual battle, the scene configuration information including a lowering lens parameter corresponding to each spawn point, the lowering lens parameter being configured for indicating a plurality of gradually lowering lens views; and displaying, based on the plurality of gradually lowering lens views indicated by the lowering lens parameter corresponding to the target spawn point, a plurality of scene pictures of the 3D virtual scene under the plurality of gradually lowering lens views during gradual lowering and change from the wide-shot lens view to the second close-shot lens view.

The scene configuration information of the 3D virtual scene further includes the lowering lens parameter corresponding to the selected target spawn point, the lowering lens parameter being configured for indicating a plurality of gradually lowering lens views. To be specific, in the battle game, a corresponding lowering lens parameter may be configured for each spawn point in the 3D virtual scene. The lowering lens parameter is configured for indicating a plurality of gradually lowering lens views. Each lens view has a corresponding scene lens parameter, that is, a focal length, an angle, a position, a lens special effect, and the like of a lens. In this case, the lowering lens parameter may be understood as a set of scene lens parameters respectively corresponding to the plurality of gradually lowering lens views. The terminal may determine a lens view for observing the 3D virtual scene based on a scene lens parameter, under which the local scene of the 3D virtual scene can be observed. The terminal may display the local scene. The terminal obtains a plurality of continuously changing scene lens parameters corresponding to the gradually lowering lens views, and may determine a plurality of continuous and gradually lowering lens views for observing the 3D virtual scene through the plurality of scene lens parameters. A plurality of gradually lowering lens pictured of the 3D virtual scene may be observed through the lens views.

FIG. 8 is a schematic diagram of a lens view lowering process according to an embodiment. Referring to FIG. 7, the scene displayed by the terminal gradually lowers from the second local scene through the lens view. During the changing of the lens view, decreasing scene pictures of the 3D virtual scene are formed under the gradually lowering lens view, elements in the 3D virtual scene are increasingly larger, and scene details at the target spawn point of the 3D virtual scene are gradually displayed. In the process, the player can clearly learn surroundings in the 3D virtual scene, so that the player can have global understanding of the surroundings of the target spawn point at the point selection stage before the virtual battle is started, and interruption of the immersive game experience as a result of leaving the 3D virtual scene in which the virtual battle is performed is avoided.

In an embodiment, after displaying a third local scene of the 3D virtual scene, the method further includes: displaying an operation control configured to control the target virtual object in the third local scene in an overlay manner; and controlling the target virtual object to move in the 3D virtual scene from the target spawn point in response to a trigger operation performed on the operation control.

The operation control is a control that can control the target virtual object to move and be loaded with a virtual prop. For example, the control may include a backpack control, an orientation indication control, a loudspeaker switch, a microphone switch, a control configured to move a virtual character, a control configured to control a virtual character to perform a preset action, a control configured to control a virtual character to be loaded with a virtual prop, and the like. In addition, the third local scene may further include display elements such as a session message, a chat control, and a thumbnail map of the 3D virtual scene.

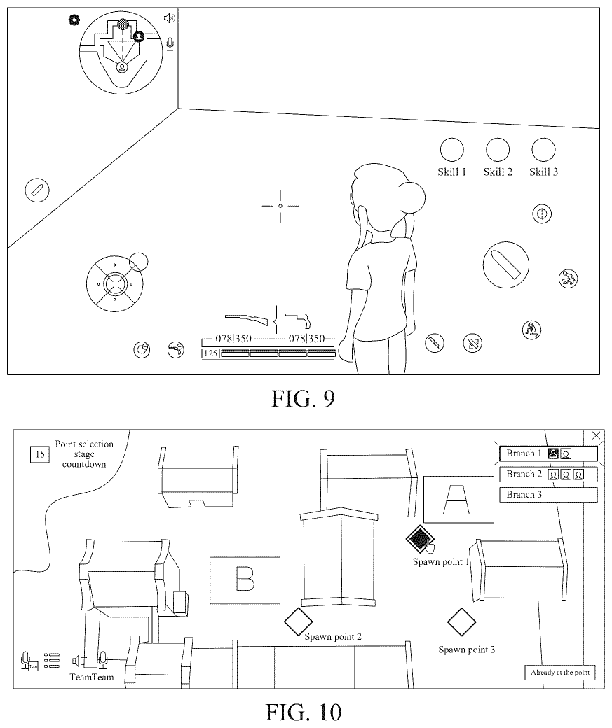

FIG. 9 is a schematic diagram of an operation control displayed in a third local scene in an overlay manner according to an embodiment. Referring to FIG. 9, When the lens view changes to the second close-shot lens view, the operation control is displayed in the third local scene. In this case, the player may control the target virtual object at the spawn point through the operation control, to start the virtual battle, for example, control the target virtual object to start to perform an operation such as moving or shooting.

In an embodiment, after the displaying a second local scene of the 3D virtual scene under the wide-shot lens view includes: marking the plurality of spawn points in the second local scene, the plurality of spawn points including the preset spawn point of the target virtual object, the preset spawn point being marked in a first pattern, spawn points of the plurality of spawn points other than the preset spawn point being marked in a second pattern, the first pattern representing a selected state, and the second pattern representing an unselected state.

When the lens view changes to the wide-shot lens view, the second local scene of the 3D virtual scene under the wide-shot lens view displayed by the terminal includes a plurality of spawn points. The terminal may mark the plurality of spawn points, and select a preset spawn point of the plurality of spawn points by default. The preset spawn point is marked in the first pattern, and others of the plurality of spawn points are marked in the second pattern. The first pattern represents the selected state, and the second pattern represents the unselected state.

FIG. 10 is a schematic diagram of a plurality of marked spawn points according to an embodiment. Referring to FIG. 10, the plurality of spawn points in the second local scene are all marked by a rhombus, a selected spawn point 1 is marked by a solid rhombus, a spawn point 2 and a spawn point 3 that are not selected are marked by a hollow rhombus. Certainly, a pattern for marking the spawn point is not limited in this embodiment of this application, provided that the selected state and the unselected state are represented through different patterns.

In an embodiment, the selecting a target spawn point from the plurality of spawn points includes: updating a display pattern of the preset spawn point to the second pattern and updating a display pattern of the target spawn point to the first pattern in response to a selection operation performed on the target spawn point of the plurality of spawn points.

In this embodiment, the player may trigger a corresponding operation on the marked spawn point. When the selection operation is triggered on the target spawn point, in the displayed second local scene, the display pattern of the preset spawn point is updated to the second pattern, and the display pattern of the selected target spawn point is updated to the first pattern, to indicate that the target spawn point is currently selected as the spawn point for the target virtual object to perform the virtual battle.

In an embodiment, the method further includes: displaying a spawn point prompt area in the second local scene in an overlay manner; and displaying a selected box corresponding to each spawn point in the spawn point prompt area, object information located in the selected box indicating that a corresponding virtual object has selected a corresponding spawn point, and object information of the target virtual object being located in a selected box corresponding to the preset spawn point.

The spawn point prompt area is configured for displaying prompt information indicating whether each spawn point is selected by a plurality of virtual objects (which may be virtual objects belonging to the same camp as the target virtual object) participating in a current virtual battle. The terminal may learn from the server which spawn point is selected by the virtual objects belonging to the same camp as the target virtual object. The spawn point prompt area includes the selected box corresponding to each spawn point. The selected box displays the object information of the virtual object selecting the spawn point. The object information may be attribute information of the virtual object, such as an avatar representing the virtual object. The object information may alternatively be account information of a control account of the virtual object, such as an account avatar or an account nickname. The object information located in the corresponding selected box indicates that the corresponding virtual object selects the spawn point. In this way, during selection of a spawn point by the player, a spawn point selection status of another virtual object (such as another virtual object of the same camp) may be displayed in real time, so that the player has global understanding about tactics planning and teammate distribution before the virtual battle, thereby improving game experience. In some embodiments, in the spawn point prompt area, the object information of the target virtual object controlled by the terminal and object information of another virtual object are displayed in corresponding selected boxes in different patterns. For example, object information (whose color value is, for example, 75FBC3 100%) of a virtual object of a teammate and the object information (whose color value is, for example, FF874D 100%) of the target virtual object controlled by the player are distinguished from each other in color value.

In an embodiment, in response to a selection operation performed on the target spawn point in the second local scene, a display pattern of the preset spawn point is updated to the second pattern, a display pattern of the target spawn point is updated to the first pattern, and the object information of the target virtual object is switched to a selected box corresponding to the target spawn point.

Specifically, when the player triggers a point selection operation on the spawn point marked in the second local scene, the object information is synchronously updated to the selected box corresponding to the marked spawn point.

In an embodiment, the method further includes: displaying, in the spawn point prompt area, object information of other virtual objects in the first camp in which the target virtual object is located in a selected box corresponding to a selected spawn point, the other virtual objects being virtual objects in the first camp other than the target virtual object.

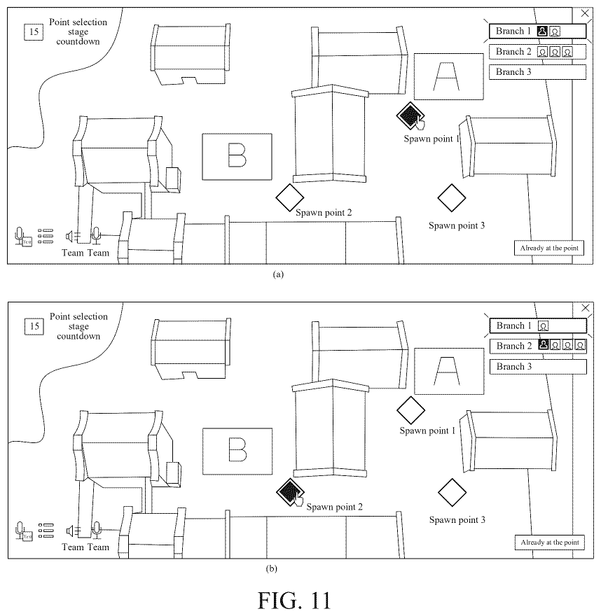

FIG. 11 is a schematic diagram of a spawn point prompt area displayed in a second local scene in an overlay manner according to an embodiment. Referring to (a) of FIG. 11, a preset spawn point 1 selected by default is marked by a solid rhombus, and a spawn point 2 and a spawn point 3 that are not selected are marked by a hollow rhombus. A selected box corresponding to the spawn point 1 in the spawn point prompt area includes object information of the target virtual object, and further includes object information of another virtual objects in the same camp, a selected box corresponding to the spawn point 2 also includes object information of another virtual object in the same camp, and a selected box corresponding to the spawn point 3 does not include any object information, which indicates that no other virtual objects in the same camp currently select the spawn point 3. When the player clicks/taps the spawn point 2, the spawn point 2 is marked by a solid rhombus, and the spawn points 1 and 3 that are not selected are marked by a hollow rhombus. In addition, the object information of the target virtual object is moved from the selected box corresponding to the spawn point 1 to the selected box corresponding to the spawn point 2. When the player may confirm, through a confirmation control, that the spawn point 2 is selected as the spawn point of the target virtual object, a gradually lowering lens picture of the 3D virtual scene may start to be displayed.

In an embodiment, in response to a trigger operation performed on a selected box corresponding to the target spawn point of the plurality of spawn points, the object information of the target virtual object is switched to the selected box corresponding to the target spawn point, a display pattern of the preset spawn point in the second local scene is updated to the second pattern, and a display pattern of the target spawn point in the second local scene is updated to the first pattern.

Specifically, when the player selects the spawn point in the spawn point prompt area displayed in the second local scene, the pattern of the selected spawn point in the second local scene synchronously changes to the second pattern representing the selected state.

In an embodiment, the method further includes: marking a plurality of target areas in the second local scene; and displaying recommended paths from the preset spawn point to all target areas in the second local scene in an overlay manner.

The target area is an area to which the virtual object needs to move in the virtual battle. The plurality of spawn points marked in the second local scene may be located near the target area. During point selection by the player, the terminal may mark the plurality of spawn points located in the second local scene, may mark the plurality of target areas in the second local scene, and may mark the recommended paths for traveling from the selected spawn point to all of the target areas.

In an embodiment, the method further includes: canceling, in response to a selection operation performed on the target spawn point of the plurality of spawn points, the displaying of the recommended paths from the preset spawn point to all of the target areas, and displaying the recommended paths from the target spawn point to all of the target areas in the second local scene in an overlay manner.

In this embodiment, during switching between the plurality of spawn points by the player, a recommended path displayed in the second local scene is switched to that of a selected spawn point.

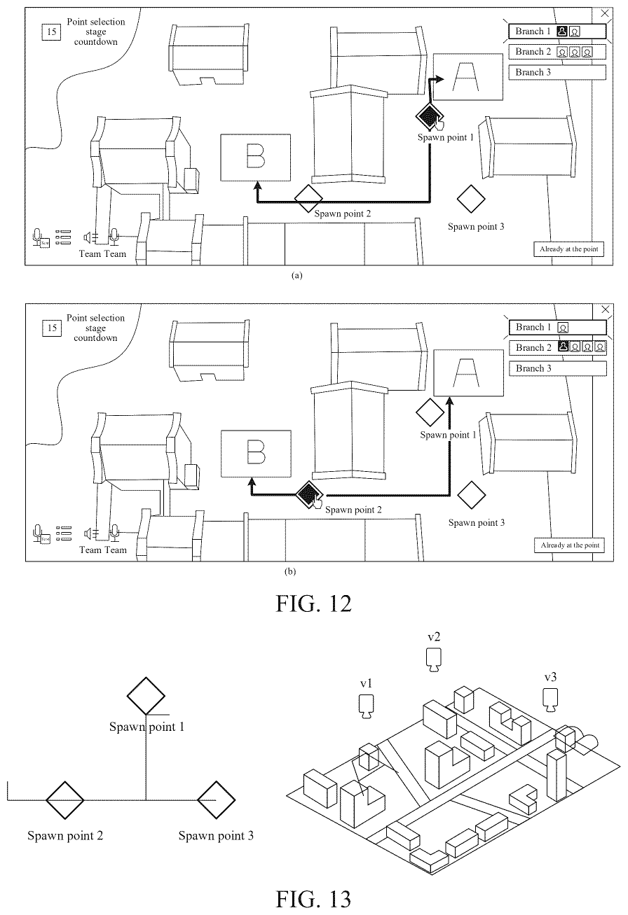

FIG. 12 is a schematic diagram of a displayed recommended path according to an embodiment. Referring to (a) of FIG. 12, when the spawn point 1 is selected, recommended paths from the spawn point 1 to a target area A and from the spawn point 1 to a target area B are displayed. Referring to (b) of FIG. 12, when the spawn point 2 is selected, recommended paths from the spawn point 2 to the target area A and from the spawn point 2 to the target area B are displayed.

FIG. 13 is a schematic diagram of scene configuration information of a 3D virtual map according to an embodiment. Referring to FIG. 13, the scene configuration information indicates three spawn points, i.e., 1, 2, and 3 in the 3D virtual scene, and further indicates scene lenses v1, v2, and v3 corresponding to the spawn points. The scene lens corresponding to each spawn point is determined through a corresponding scene lens parameter.

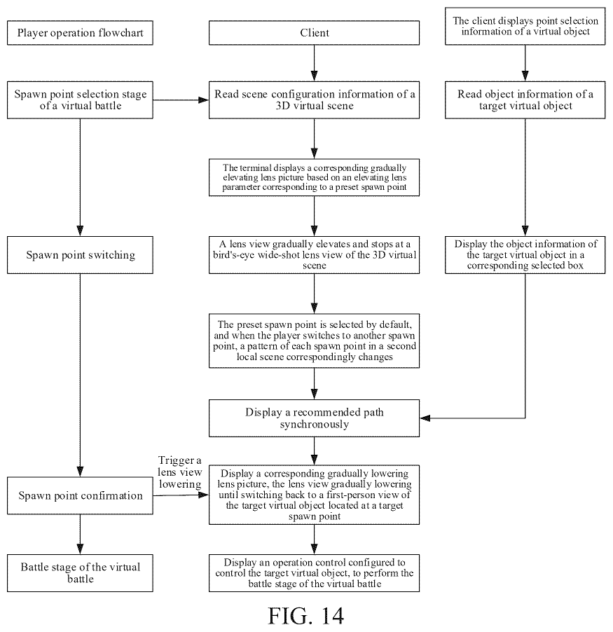

FIG. 14 is a timing diagram of a virtual scene display method according to an embodiment. Referring to FIG. 14, when the point selection stage of the virtual battle is started, after a player selects a virtual character as a control object of the virtual battle, a battle game client reads scene configuration information of the 3D virtual scene. The scene configuration information includes a preset spawn point in the 3D virtual scene and a scene lens parameter of the preset spawn point, and further includes an elevating lens parameter corresponding to the preset spawn point and a lowering lens parameter corresponding to each spawn point. The scene lens parameter indicates that a lens view corresponding to the 3D virtual scene at the preset spawn point is the first close-shot lens view, and the terminal displays, based on the first close-shot lens view, the first local scene at the preset spawn point at which the target virtual object is located. Then the terminal displays a corresponding gradually elevating lens picture based on the elevating lens parameter corresponding to the preset spawn point without any operation of the player. The lens view gradually elevates and stops at a bird's-eye wide-shot lens view of the 3D virtual scene. The bird's-eye view includes a plurality of spawn points in the 3D virtual scene. In this case, the second local scene is displayed. The preset spawn point is selected by default in the second local scene. When the player switches to another spawn point, a pattern of each spawn point in the second local scene correspondingly changes, a recommended path is synchronously displayed, and an object in a selected box corresponding to each spawn point in the spawn point prompt area synchronously changes. After the player confirms that the target spawn point is the spawn point of the target virtual object, the terminal triggers a point selection completion instruction. The instruction triggers the terminal to read a lowering lens parameter corresponding to the target spawn point, and to display a corresponding gradually lowering lens picture based on the lowering lens parameter. The lens view gradually lowers to switch back to a first-person angle of the target virtual object located at the target spawn point, that is, the second close-shot lens view. In this case, the terminal displays the third local scene, that is, a scene picture when the lens view is switched back. The terminal may display the operation control configured for controlling the target virtual object in the third local scene in an overlay manner. In this way, a battle stage of the virtual battle is formed.

In a specific embodiment, the virtual scene display method performed by the terminal includes the following operations:
1: Display a virtual battle interface at a spawn point selection stage of a virtual battle.
2: Read scene configuration information of a 3D virtual scene of the virtual battle, the scene configuration information including a preset spawn point in the 3D virtual scene and a scene lens parameter of the preset spawn point, the scene lens parameter indicating that a lens view corresponding to the 3D virtual scene at the preset spawn point is a first close-shot lens view.
3: Display a first local scene in a virtual battle interface based on the first close-shot lens view, the first local scene being a local scene in which a target virtual object is located at the preset spawn point of the 3D virtual scene.
4: Display virtual objects of a first camp of the virtual battle in the first local scene, the virtual objects of the first camp including the target virtual object.
5: Read scene configuration information of the 3D virtual scene of the virtual battle after displaying of the virtual object ends, the scene configuration information including an elevating lens parameter corresponding to the preset spawn point, the elevating lens parameter being configured for indicating a plurality of gradually elevating lens views.
6: Display, based on the plurality of gradually elevating lens views, a plurality of scene pictures of the 3D virtual scene under the plurality of gradually elevating lens views during gradual elevation and change from the first close-shot lens view to a wide-shot lens view.
7: Display a second local scene of the 3D virtual scene under the wide-shot lens view when the lens view changes to the wide-shot lens view, the second local scene including a plurality of spawn points.
8: Mark a plurality of spawn points in the second local scene, the plurality of spawn points including the preset spawn point of the target virtual object, the preset spawn point being marked in a first pattern, others of the plurality of spawn points being marked in a second pattern, the first pattern representing a selected state, and the second pattern representing an unselected state.
9: Display a spawn point prompt area in the second local scene in an overlay manner, and display a selected box corresponding to each spawn point in the spawn point prompt area, object information located in the selected box indicating that a corresponding spawn point has been selected, and object information of the target virtual object being located in a selected box corresponding to the preset spawn point.
10: Update, in response to a spawn point switching operation performed on the plurality of spawn points, a display pattern of the preset spawn point to the second pattern, update a display pattern of a spawn point to which the switching is performed to the first pattern, and switch the object information of the target virtual object to a selected box corresponding to the spawn point to which the switching is performed.
11: Switch, in response to a trigger operation performed on a selected box corresponding to the target spawn point of the plurality of spawn points, the object information of the target virtual object to the selected box corresponding to the target spawn point, update a display pattern of the preset spawn point in the second local scene to the second pattern, and update a display pattern of the target spawn point in the second local scene to the first pattern.
12: Use the target spawn point as a spawn point for the target virtual object to perform the virtual battle in response to a selection confirmation operation performed on the target spawn point.
13: Read the scene configuration information of the 3D virtual scene of the virtual battle, the scene configuration information including a lowering lens parameter corresponding to each spawn point, the lowering lens parameter being configured for indicating a plurality of gradually lowering lens views.
14: Display, based on the plurality of gradually lowering lens views indicated by the lowering lens parameter corresponding to the target spawn point, scene pictures of the 3D virtual scene under the plurality of gradually lowering lens views during gradual lowering and change from the wide-shot lens view to a second close-shot lens view.
15: Display a third local scene in which the target virtual object is located at the target spawn point of the 3D virtual scene when the lens view changes to the second close-shot lens view, the third local scene being a local scene in which the lens view is the second close-shot lens view and the target virtual object is located at the target spawn point of the 3D virtual scene.
16: Display an operation control configured to control the target virtual object in the third local scene in an overlay manner.
17: Control the target virtual object to move in the 3D virtual scene from the target spawn point in response to a trigger operation performed on the operation control.

An embodiment of this application further provides an application scenario. When a battle game client is enabled and a spawn point selection stage is started, the battle game client starts reading a scene configuration parameter corresponding to a current 3D map at the spawn point selection stage. The scene configuration information includes a preset spawn point in the current 3D map, a scene lens parameter of the preset spawn point, and an elevating lens parameter corresponding to the preset spawn point, so as to determine a character displaying lens view and a bird's-eye lens view of the 3D map. Then a lens animation is played based on the read elevating lens parameter, and the lens view finally stops at a top view of the entire 3D map, so that a player can obtain key point information (for example, a plurality of selectable spawn points, target areas, and traveling paths) of the entire 3D map. When the lens animation stops at the bird's-eye view, respective selection boxes of selectable spawn points in the 3D map are displayed in a list on a right side of an interface, and the preset spawn point is selected by default. A selected state and an unselected state are synchronized to a display pattern of a spawn point in the 3D map. Object information of the selected virtual object is read, and the object information is displayed on a right side of the selected spawn point option. When the player clicks/taps a selected box of a spawn point in the unselected state, the clicked/tapped selected box of the spawn point and a pattern of the spawn point in the 3D map are switched to the selected state. Next, the terminal generates a recommended path based on a connection line between a location of the spawn point selected by the player and the target area of the map, and renders and displays the recommended path in the current scene. After clicking/tapping a “Confirm” button, the terminal transmits an end instruction to the battle game client, to restore the lens view to the first-person view, and transmit a 3D model of the target virtual object to the target spawn point in the scene. After the 3D model and the lens view of the target virtual object are both restored, the operation control configured to control the virtual object is displayed. In this case, all operation controls are activated, and the player enters a virtual battle state.

Although the operations in the flowcharts involved in the foregoing embodiments are displayed in a sequence based on indication of arrows, the operations are not necessarily performed sequentially based on the sequence indicated by the arrows. Unless otherwise explicitly specified in this application, execution of the operations is not strictly limited, and the operations may be performed in other sequences. Moreover, at least some of the operations involved in the foregoing embodiments may include a plurality of operations or a plurality of stages. The operations or stages are not necessarily performed at the same moment but may be performed at different moments, and the operations or the stages are not necessarily sequentially performed, but may be performed alternately with other operations or at least some operations or stages of other operations.

Based on the same inventive concept, an embodiment of this application further provides a virtual scene display apparatus configured to implement the foregoing virtual scene display method. An implementation provided by the apparatus to resolve the problem is similar to the implementation recorded in the foregoing method. Therefore, for specific limitations in one or more embodiments of the virtual scene display apparatus provided below, reference may be made to the foregoing limitations on the virtual scene display method.

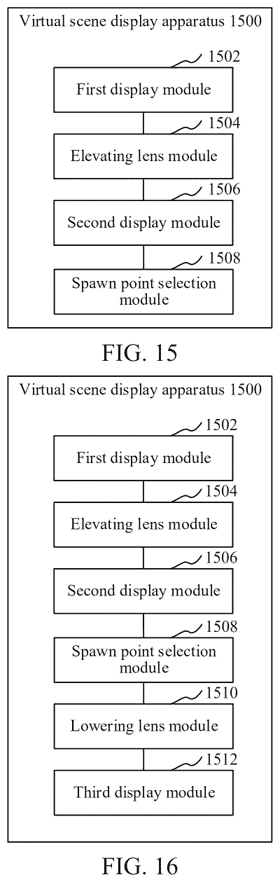

In an embodiment, as shown in FIG. 15, a virtual scene display apparatus 1500 is provided, which includes a first display module 1502, an elevating lens module 1504, a second display module 1506, and a spawn point selection module 1508.

The first display module 1502 is configured to display a first local scene at a spawn point selection stage of a virtual battle, the first local scene being a local scene of a 3D virtual scene under a first close-shot lens view, and the first local scene including a target virtual object.

The elevating lens module 1504 is configured to display a gradually elevating lens picture of the 3D virtual scene, the gradually elevating lens picture being a scene picture of the 3D virtual scene under a gradually elevating lens view during gradual elevation of the lens view from the first close-shot lens view to a wide-shot lens view.

The second display module 1506 is configured to display a second local scene when the lens view changes to the wide-shot lens view, the second local scene being a local scene of the 3D virtual scene under the wide-shot lens view, and the second local scene including a plurality of spawn points.

The spawn point selection module 1508 is configured to select a target spawn point from the plurality of spawn points.

In an embodiment, the first display module 1502 is further configured to: display a virtual battle interface at the spawn point selection stage of the virtual battle; and display the first local scene of the 3D virtual scene in the virtual battle interface, the first local scene being a local scene of the 3D virtual scene under the first close-shot lens view, the first local scene being a local scene at a preset spawn point of the 3D virtual scene, and the first local scene including the target virtual object located at the preset spawn point.

In an embodiment, the first display module 1502 is further configured to: read scene configuration information of the 3D virtual scene of the virtual battle, the scene configuration information including the preset spawn point in the 3D virtual scene and a scene lens parameter of the preset spawn point, the scene lens parameter indicating that a lens view corresponding to the 3D virtual scene at the preset spawn point is the first close-shot lens view; and display the first local scene in which the target virtual object is located at the preset spawn point of the 3D virtual scene based on the first close-shot lens view.

In an embodiment, the scene configuration information further includes an elevating lens parameter corresponding to the preset spawn point, the elevating lens parameter being configured for indicating a plurality of gradually elevating lens views.

The elevating lens module 1504 is further configured to display, based on the plurality of gradually elevating lens views, a plurality of scene pictures of the 3D virtual scene under the plurality of gradually elevating lens views during gradual elevation and change from the first close-shot lens view to the wide-shot lens view.

In an embodiment, as shown in FIG. 16, the apparatus 1500 further includes:
a third display module 1512, configured to display a third local scene, the third local scene being a local scene of the 3D virtual scene under a second close-shot lens view, and the third local scene including the target virtual object located at the target spawn point of the 3D virtual scene.

In an embodiment, as shown in FIG. 16, the apparatus 1500 further includes:
a lowering lens module 1510, configured to display a gradually lowering lens picture of the 3D virtual scene, the gradually lowering lens picture being a scene picture of the 3D virtual scene under a gradually lowering lens view during gradual lowering of the lens view from the wide-shot lens view to the second close-shot lens view.

The third display module 1512 is further configured to display the third local scene when the lens view changes to the second close-shot lens view, the third local scene being the local scene of the 3D virtual scene under the second close-shot lens view, the third local scene being a local scene of the 3D virtual scene at the target spawn point, and the third local scene including the target virtual object located at the target spawn point.

In an embodiment, the third display module 1512 is further configured to: read the scene configuration information of the 3D virtual scene of the virtual battle, the scene configuration information including a lowering lens parameter corresponding to each spawn point, the lowering lens parameter being configured for indicating a plurality of gradually lowering lens views; and display, based on the plurality of gradually lowering lens views indicated by the lowering lens parameter corresponding to the target spawn point, a plurality of scene pictures of the 3D virtual scene under the plurality of gradually lowering lens views during gradual lowering and change from the wide-shot lens view to the second close-shot lens view.

In an embodiment, the apparatus 1500 further includes:
an operation control display module, configured to: display an operation control configured to control the target virtual object in the third local scene in an overlay manner; and control the target virtual object to move in the 3D virtual scene from the target spawn point in response to a trigger operation performed on the operation control.

In an embodiment, the second display module 1506 is further configured to mark the plurality of spawn points located in the second local scene, the plurality of spawn points including the preset spawn point of the target virtual object, the preset spawn point being marked in a first pattern, spawn points of the plurality of spawn points other than the preset spawn point being marked in a second pattern, the first pattern representing a selected state, and the second pattern representing an unselected state.

In an embodiment, the spawn point selection module 1508 is further configured to update a display pattern of the preset spawn point to the second pattern and update a display pattern of the target spawn point to the first pattern in response to a selection operation performed on the target spawn point of the plurality of spawn points.

In an embodiment, the spawn point selection module 1508 is further configured to: display a spawn point prompt area in the second local scene in an overlay manner; and display a selected box corresponding to each spawn point in the spawn point prompt area, object information located in the selected box indicating that a corresponding virtual object has selected a corresponding spawn point, and object information of the target virtual object being located in a selected box corresponding to the preset spawn point.

In an embodiment, the spawn point selection module 1508 is further configured to switch, in response to a trigger operation performed on a selected box corresponding to the target spawn point of the plurality of spawn points, the object information of the target virtual object to the selected box corresponding to the target spawn point, update a display pattern of the preset spawn point in the second local scene to the second pattern, and update a display pattern of the target spawn point in the second local scene to the first pattern.

In an embodiment, the spawn point selection module 1508 is further configured to update, in response to a selection operation performed on the target spawn point in the second local scene, a display pattern of the preset spawn point to the second pattern, update a display pattern of the target spawn point to the first pattern, and switch the object information of the target virtual object to a selected box corresponding to the target spawn point.

In an embodiment, the spawn point selection module 1508 is further configured to display, in the spawn point prompt area, object information of other virtual objects in the first camp in which the target virtual object is located in a selected box corresponding to a selected spawn point.

In an embodiment, the spawn point selection module 1508 is further configured to mark a plurality of target areas in the second local scene; and display recommended paths from the preset spawn point to all target areas in the second local scene in an overlay manner.

In an embodiment, the spawn point selection module 1508 is further configured to cancel, in response to a selection operation performed on the target spawn point of the plurality of spawn points, the displaying of the recommended paths from the preset spawn point to all of the target areas, and display the recommended paths from the target spawn point to all of the target areas in the second local scene in an overlay manner.

According to the foregoing virtual scene display apparatus 1500, the first local scene is displayed at the spawn point selection stage of the virtual battle. The first local scene is a local scene of the 3D virtual scene under the first close-shot lens view. The first local scene includes the target virtual object. After the target virtual object is displayed, the gradually elevating lens picture of the 3D virtual scene is displayed. A scene picture of the 3D virtual scene under the gradually elevating lens view during the gradual elevation of the lens view from the first close-shot lens view to the wide-shot lens view is the gradually elevating lens picture. The second local scene is displayed when the lens view changes to the wide-shot lens view. The second local scene is a local scene of the 3D scene under the wide-shot lens view. The second local scene includes a plurality of spawn points. Then the target spawn point may be directly selected from the 3D virtual scene. In other words, the lens view displaying the virtual object is directly switched to the wide-shot lens view of the 3D virtual scene, so that the player can observe the scene environment of the 3D virtual scene when selecting the spawn point. In addition, the lens view switching is seamless, providing very smooth experience. The lens switching is completely performed in the 3D virtual scene, without a need to perform camera movement to switch to the simplified planar diagram to select the spawn point, which avoids interruption of immersive experience of the 3D virtual scene as a result of switching between the 3D virtual scene and the simplified planar diagram, thereby significantly improving game experience of players. In addition, neither additional configuration and storage of the simplified planar diagram on the terminal or the server nor additional rendering of the simplified planar diagram on the terminal or the server is required, thereby reducing processing resources of the terminal and the server that need to be occupied.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. All or some of the modules in the foregoing virtual scene display apparatus 1500 may be implemented by a software, a hardware, or a combination thereof. The foregoing modules may be built in or independent of a processor of a computer device in a form of hardware, or may be stored in a memory of the computer device in a form of software, for invoke by the processor to execute the operations corresponding to the foregoing modules.

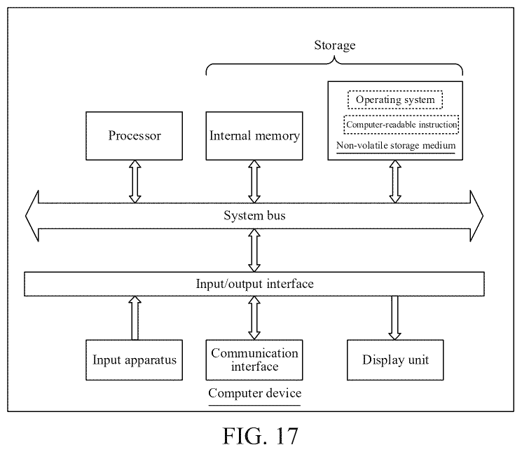

In an embodiment, a computer device is provided. The computer device may be a terminal, and an internal structural diagram of the computer device may be shown in FIG. 17. The computer device includes a processor, a memory, an input/output interface, a communication interface, a display unit, and an input apparatus. The processor, the memory, and the input/output interface are connected through a system bus. The communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium has an operating system and computer-readable instructions stored therein. The internal memory provides an environment for running of the operating system and the computer-readable instructions in the non-volatile storage medium. The input/output interface of the computer device is configured for information exchange between the processor and an external device. The communication interface of the computer device is configured to perform wired or wireless communication with an external terminal. The wireless communication may be implemented through wireless fidelity (Wi-Fi), a mobile cellular network, near field communication (NFC), or another technology. The computer-readable instructions, when executed by the processor, implement a virtual scene display method. The display unit of the computer device is configured to form a visible picture, and may be a display screen, a projection apparatus, or a virtual reality imaging apparatus. The display screen may be a liquid crystal display screen or an electronic ink display screen. The input apparatus of the computer device may be a touch layer covering the display screen, or may be a button, a trackball, or a touchpad arranged on a housing of the computer device, or may be an external keyboard, a touchpad, a mouse, or the like.

A person skilled in the art may understand that the structure shown in FIG. 17 is merely a block diagram of a partial structure related to the solution of this application, and does not constitute a limitation on the computer device to which the solution of this application is applied. Specifically, the computer device may include more or fewer components than those shown in the figure, or some merged components, or different component arrangements.

In an embodiment, a computer device is provided, which includes a memory and a processor. The memory has computer-readable instructions stored therein, and the processor, when executing the computer-readable instructions, implements the operations in the virtual scene display method provided in the embodiments of this application.

In an embodiment, a non-transitory computer-readable storage medium is provided, which has computer-readable instructions stored therein. The computer-readable instructions, when executed by a processor, implement the operations of the virtual scene display method provided in the embodiments of this application.

In an embodiment, a computer program product is provided, which includes computer-readable instructions. The computer-readable instructions, when executed by a processor, implement the operations of the virtual scene display method provided in the embodiments of this application.

User information (including but not limited to user device information and user personal information) and data (including but not limited to data for analysis, stored data, and displayed data) involved in this application are all information and data authorized by users or fully authorized by all parties, and collection, use, and processing of relevant data need to comply with relevant laws, regulations, and standards of relevant countries and regions.

A person of ordinary skill in the art may understand that all or some of the processes of the method in the foregoing embodiments may be performed by instructing relevant hardware through computer-readable instructions. The computer-readable instructions may be stored in a non-volatile computer-readable storage medium. When the computer-readable instructions are executed, the processes of the foregoing method embodiments may be implemented. Any reference to a memory, a database, or another medium used in the embodiments provided in this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a RAM, an external cache, or the like. As an illustration rather than a limitation, the RAM is available in various forms, such as a static random access memory (SRAM) or a dynamic random access memory (DRAM). The database involved in the embodiments provided in this application may include at least one of a relational database and a non-relational database. The non-relational database may include a blockchain-based distributed database, but is not limited thereto. The processor involved in the embodiments provided in this application may be a general-purpose processor, a central processing unit, a graphics processing unit, a digital signal processor, a programmable logic device, a quantum computing-based data processing logic device, but is not limited thereto.

The technical features of the foregoing embodiments may be combined in different manners. To make the description concise, not all possible combinations of the technical features in the foregoing embodiments are described. However, the combinations of these technical features are considered to fall within the scope recorded in this specification provided that no conflict exists.

The foregoing embodiments merely show some implementations of this application, which are described specifically and in detail, but cannot be construed as a limitation on the patent scope of this application. A person of ordinary skill in the art may make transformations and improvements without departing from the concept of this application. These transformations and improvements fall within the protection scope of this application. Therefore, the protection scope of this application shall be subject to the appended claims.

What is claimed is:

1. A virtual scene display method performed by a computer device, the method comprising:
displaying a first local scene at a spawn point selection stage of a virtual battle, wherein the first local scene including a target virtual object is a local scene picture of a three-dimensional (3D) virtual scene under a first close-shot lens view;
generating and displaying a plurality of scene pictures of the 3D virtual scene sequentially during a gradual elevation of a lens view from the first close-shot lens view to a wide-shot lens view;
displaying a second local scene including a plurality of spawn points when the lens view changes to the wide-shot lens view, wherein the second local scene including a plurality of spawn points is a local scene picture of the 3D virtual scene under the wide-shot lens view; and
selecting a target spawn point from the plurality of spawn points for the target virtual object.

2. The method according to claim 1, wherein the displaying the first local scene at the spawn point selection stage of the virtual battle comprises:
displaying a virtual battle interface at the spawn point selection stage of the virtual battle; and
displaying the first local scene of the 3D virtual scene in the virtual battle interface, wherein the first local scene is a local scene picture at the target spawn point of the 3D virtual scene and the first local scene includes the target virtual object located at the target spawn point.

3. The method according to claim 2, wherein the displaying the first local scene of the 3D virtual scene in the virtual battle interface comprises:
displaying the first local scene of the 3D virtual scene in the virtual battle interface, the first local scene comprising virtual objects of a first camp of the virtual battle located at the target spawn point and comprising the target virtual object.

4. The method according to claim 1, wherein the displaying the first local scene comprises:
reading scene configuration information of the 3D virtual scene of the virtual battle, the scene configuration information comprising the target spawn point in the 3D virtual scene and a scene lens parameter of the target spawn point corresponding to the first close-shot lens view; and
displaying the first local scene based on the first close-shot lens view, wherein the first local scene including the target virtual object located at the target spawn point of the 3D virtual scene.

5. The method according to claim 1, wherein the method further comprises:
displaying a third local scene of the 3D virtual scene under a second close-shot lens view, wherein the third local scene includes the target virtual object located at the target spawn point of the 3D virtual scene.

6. The method according to claim 1, wherein the method comprises:
marking the plurality of spawn points in the second local scene, wherein the target spawn point is marked in a selected state and spawn points of the plurality of spawn points other than the target spawn point is marked in an unselected state.

7. The method according to claim 6, wherein the selecting the target spawn point from the plurality of spawn points comprises:
updating a display pattern of the target spawn point to the first pattern in response to a selection operation performed on the target spawn point of the plurality of spawn points.

8. The method according to claim 6, further comprising:
displaying a spawn point prompt area in the second local scene in an overlay manner; and
displaying a selected box corresponding to each spawn point in the spawn point prompt area, object information located in the selected box indicating that a corresponding virtual object has selected a corresponding spawn point, and object information of the target virtual object being located in a selected box corresponding to the preset spawn point.

9. The method according to claim 6, further comprising:
marking a plurality of target areas in the second local scene; and
displaying recommended paths from the target spawn point to all target areas in the second local scene in an overlay manner.

10. A computer device, comprising a memory and a processor, the memory having computer-readable instructions stored therein, and the processor, when executing the computer-readable instructions, causing the computer device to implement a virtual scene display method including:
displaying a first local scene at a spawn point selection stage of a virtual battle, wherein the first local scene including a target virtual object is a local scene picture of a three-dimensional (3D) virtual scene under a first close-shot lens view;
generating and displaying a plurality of scene pictures of the 3D virtual scene sequentially during a gradual elevation of a lens view from the first close-shot lens view to a wide-shot lens view;
displaying a second local scene including a plurality of spawn points when the lens view changes to the wide-shot lens view, wherein the second local scene including a plurality of spawn points is a local scene picture of the 3D virtual scene under the wide-shot lens view; and
selecting a target spawn point from the plurality of spawn points for the target virtual object.

11. The computer device according to claim 10, wherein the displaying the first local scene at the spawn point selection stage of the virtual battle comprises:
displaying a virtual battle interface at the spawn point selection stage of the virtual battle; and
displaying the first local scene of the 3D virtual scene in the virtual battle interface, wherein the first local scene is a local scene picture at the target spawn point of the 3D virtual scene and the first local scene includes the target virtual object located at the target spawn point.

12. The computer device according to claim 11, wherein the displaying the first local scene of the 3D virtual scene in the virtual battle interface comprises:
displaying the first local scene of the 3D virtual scene in the virtual battle interface, the first local scene comprising virtual objects of a first camp of the virtual battle located at the target spawn point and comprising the target virtual object.

13. The computer device according to claim 10, wherein the displaying the first local scene comprises:
reading scene configuration information of the 3D virtual scene of the virtual battle, the scene configuration information comprising the target spawn point in the 3D virtual scene and a scene lens parameter of the target spawn point corresponding to the first close-shot lens view; and
displaying the first local scene based on the first close-shot lens view, wherein the first local scene including the target virtual object located at the target spawn point of the 3D virtual scene.

14. The computer device according to claim 10, wherein the method further comprises:
displaying a third local scene of the 3D virtual scene under a second close-shot lens view, wherein the third local scene includes the target virtual object located at the target spawn point of the 3D virtual scene.

15. The computer device according to claim 10, wherein the method comprises:
marking the plurality of spawn points in the second local scene, wherein the target spawn point is marked in a selected state and spawn points of the plurality of spawn points other than the target spawn point is marked in an unselected state.

16. The computer device according to claim 15, wherein the selecting the target spawn point from the plurality of spawn points comprises:
updating a display pattern of the target spawn point to the first pattern in response to a selection operation performed on the target spawn point of the plurality of spawn points.

17. The computer device according to claim 15, wherein the method further comprises:
displaying a spawn point prompt area in the second local scene in an overlay manner; and
displaying a selected box corresponding to each spawn point in the spawn point prompt area, object information located in the selected box indicating that a corresponding virtual object has selected a corresponding spawn point, and object information of the target virtual object being located in a selected box corresponding to the preset spawn point.

18. The computer device according to claim 15, wherein the method further comprises:
marking a plurality of target areas in the second local scene; and
displaying recommended paths from the target spawn point to all target areas in the second local scene in an overlay manner.

19. A non-transitory computer-readable storage medium, having computer-readable instructions stored therein, the computer-readable instructions, when executed by a processor of a computer device, causing the computer device to implement a virtual scene display method including:
displaying a first local scene at a spawn point selection stage of a virtual battle, wherein the first local scene including a target virtual object is a local scene picture of a three-dimensional (3D) virtual scene under a first close-shot lens view;
generating and displaying a plurality of scene pictures of the 3D virtual scene sequentially during a gradual elevation of a lens view from the first close-shot lens view to a wide-shot lens view;
displaying a second local scene including a plurality of spawn points when the lens view changes to the wide-shot lens view, wherein the second local scene including a plurality of spawn points is a local scene picture of the 3D virtual scene under the wide-shot lens view; and
selecting a target spawn point from the plurality of spawn points for the target virtual object.

20. The non-transitory computer-readable storage medium according to claim 19, wherein the displaying the first local scene at the spawn point selection stage of the virtual battle comprises:
displaying a virtual battle interface at the spawn point selection stage of the virtual battle; and
displaying the first local scene of the 3D virtual scene in the virtual battle interface, wherein the first local scene is a local scene picture at the target spawn point of the 3D virtual scene and the first local scene includes the target virtual object located at the target spawn point.
